(19) United States
(12) Patent Application Publication
(10) Pub. No.: US 2019/0016453 A1
(43) Pub. Date: Jan. 17, 2019

(54) VERTICAL TAKE-OFF AND LANDING (VTOL) AIRCRAFT AND A PROPULSION SYSTEM FOR A VEHICLE VERTICAL TAKE-OFF AND LANDING (VTOL)

(71) Applicant: Donatas SKULSKIS, Voveriskiai (LT)

(72) Inventor: Donatas SKULSKIS, Voveriskiai (LT)

(21) Appl. No.: 16/033,239

(22) Filed: Jul. 12, 2018

Related U.S. Application Data
(60) Provisional application No. 62/531,755, filed on Jul. 12, 2017.

(51) Int. Cl. B64C 29/00; B64C 11/00; B64C 3/38; B64C 11/46

(52) U.S. Cl. CPC B64C 29/0025; B64C 11/46; B64C 3/385; B64C 11/001

(57) ABSTRACT

The present invention relates generally to a vertical take-off and landing (VTOL) aircraft and a propulsion system for a vehicle vertical take-off and landing (VTOL), for example, helicopters, others VTOL aircrafts. The claimed VTOL aircraft provides a most effective control of the aircraft equipped with such a propulsion system, performed through the optimal distribution of the airflow generated by the rotor, while maintaining the simplicity, reliability and efficiency of the aircraft design.

### CROSS REFERENCE TO RELATED APPLICATIONS

This application claims the benefit of U.S. Provisional Patent Application Ser. No. 62/531,755 filed Jul. 12, 2017, which is expressly incorporated by reference herein.

### FIELD OF THE INVENTION

The present invention relates generally to a vertical take-off and landing (VTOL) aircraft and a propulsion system for a vehicle vertical take-off and landing (VTOL), for example, helicopters, others VTOL aircrafts.

### BACKGROUND OF THE INVENTION

From existing state of the art it is known a vertical take-off and landing (VTOL) personal aircraft (U.S. Pat. No. 6,892,979, published on May 17, 2005), which is the closest one with relation to the claimed technical solution. The VTOL personal aircraft comprises a flight cabin having a central longitudinal axis extending from a flight cabin front end a flight cabin rear end and containing a flight cockpit, flight instruments, a power source mounted on the flight cabin, at least one rotor enclosure and at least one rotor arranged in the rotor enclosure, said rotor and rotor enclosure being concentrically mounted to a rotor axis integrated with a powered axle of the power source, and at least one airfoil attached to said rotor enclosure and extending outward to the right and to the left with respect to the flight cabin central longitudinal axis, wherein the attached airfoil and the flight cabin provide a lift-to-drag (L/D) ratio of the aircraft during flight, resulting from the forward motion of the aircraft through the air and excluding vertical lift provided by said rotor, of at least 4:1 when flying at an airspeed in the range of 50 to 100 MPH, whereby the wingspan of the aircraft may be adjusted during flight.

As for disadvantages of the described technical solution it should be mentioned its design, wherein the airflow generated by the rotor is directed downwards, providing only the possibility of a vertical take-off of the claimed VTOL personal aircraft, and changing the orientation of the aircraft in space, as well as changing the angular position of the aircraft is carried out using aerodynamic controls located on the airfoil consoles, in particular, with the use of ailerons, which complicates the design and does not ensure its acceptable effectiveness.

In the described technical solution as well as in other solutions of a similar purpose the rotor arranged in the rotor enclosure may also act as a wing to generate additional lift. This makes the aircraft more fuel efficient. This arrangement presents several benefits to conventional VTOL aircrafts that utilize an exposed rotor assembly such as a reducing in retreating blade stall conditions, increased safety in case of a crash which reduces debris and injuries by rotating blades, and increased safety when flying in urban areas close to buildings as it will nothing happen even if aircraft body gently touches the wall. The enclosed rotor design can also make flights safer in crowded skies with high chances of being hit by drones. It will also allow for using smaller diameter rotor which allows a reduction in overall helicopter size. However, the problem still to be solved concerns providing a most effective control of the aircraft equipped with such a propulsion system, performed through the optimal distribution of the airflow generated by the rotor, while maintaining the simplicity, reliability and efficiency of the aircraft design.

### SUMMARY OF THE INVENTION

According to the present invention, the problem of the prior art is solved by developing a vertical take-off and landing (VTOL) aircraft and a propulsion system for a vehicle vertical take-off and landing (VTOL).

In the first aspect the claimed invention is a vertical take-off and landing (VTOL) aircraft, comprising a flight cabin having a central longitudinal axis extending from a flight cabin front end to a flight cabin rear end and containing a flight cockpit, flight instruments, a power source mounted on the flight cabin, at least one rotor enclosure and at least one rotor arranged in the rotor enclosure, said rotor and rotor enclosure being concentrically mounted to a rotor axis integrated with a powered axle of the power source, and at least one airfoil attached to said rotor enclosure and extending outward to the right and to the left with respect to the flight cabin central longitudinal axis, wherein said airfoil is provided with an air-supply-duct connecting the rotor enclosure and an airfoil end having at least one outlet opening on the side of an airfoil trailing edge, said airfoil is configured to rotate with respect to an airfoil axis.

In the second aspect, the claimed invention is a propulsion system for a vehicle vertical take-off and landing (VTOL), comprising at least one rotor enclosure and at least one rotor arranged in the rotor enclosure, said rotor and rotor enclosure being concentrically mounted to a rotor axis configured to be integrate with a powered axle of the VTOL aircraft power source, and at least one airfoil attached to said rotor enclosure and extending outward in the opposite direction with respect to the rotor enclosure lateral sides, wherein said airfoil is provided with an air-supply-duct connecting the rotor enclosure and an airfoil end having at least one outlet opening on the side of an airfoil trailing edge, said airfoil is configured to rotate with respect to an airfoil axis.

The Summary of the Invention is provided to introduce the main concept of the invention in a simplified form that is further described below in the Detailed Description of the Invention. The Summary of the Invention is not intended to identify essential features of the claimed subject matter, nor is it intended to be used to limit the scope of the claimed subject matter.

### BRIEF DESCRIPTION OF THE DRAWINGS

FIG. 1 is a perspective view of an example embodiment of the VTOL aircraft according to one of the preferred embodiments of the present invention, where the airfoils are in their initial position.

FIG. 2 is a perspective view of an example embodiment of the VTOL aircraft according to one of the preferred embodiments of the present invention, where the airfoils are rotated by 90 degrees down in respect of their initial position.

FIG. 3 is a side view of an example embodiment of the VTOL aircraft according to one of the preferred embodiments of the present invention, where the airfoils are in their initial position.

FIG. 4 is a top view of an example embodiment of the VTOL aircraft according to one of the preferred embodiments of the present invention, where the airfoils are in their initial position.

### DETAILED DESCRIPTION OF THE INVENTION

Pursuant to the first aspect of the present invention, the VTOL aircraft comprises a flight cabin having a central longitudinal axis extending from a flight cabin front end to a flight cabin rear end and containing a flight cockpit, flight instruments, a power source mounted on the flight cabin, at least one rotor enclosure and at least one rotor arranged in the rotor enclosure, said rotor and rotor enclosure being concentrically mounted to a rotor axis integrated with a powered axle of the power source, and at least one airfoil attached to said rotor enclosure and extending outward to the right and to the left with respect to the flight cabin central longitudinal axis, wherein said airfoil is provided with an air-supply-duct connecting the rotor enclosure and an airfoil end having at least one outlet opening on the side of an airfoil trailing edge, said airfoil is configured to rotate with respect to an airfoil axis.

Pursuant to the second aspect of the claimed invention a propulsion system for a vehicle vertical take-off and landing (VTOL) comprises at least one rotor enclosure and at least one rotor arranged in the rotor enclosure, said rotor and rotor enclosure being concentrically mounted to a rotor axis configured to be integrate with a powered axle of the VTOL aircraft power source, and at least one airfoil attached to said rotor enclosure and extending outward in the opposite direction with respect to the rotor enclosure lateral sides, wherein said airfoil is provided with an air-supply-duct connecting the rotor enclosure and an airfoil end having at least one outlet opening on the side of an airfoil trailing edge, said airfoil configured to rotate with respect to an airfoil axis.

The design described above is simple and effective, since it allows a spatial position change of the aircraft by redirecting the airflow from the outlet on the side of an airfoil trailing edge of the airfoil, which allows for excluding the aerodynamic controls used before and thus for increasing the reliability of the described design. Thus, in the initial position of the airfoil, a horizontal flight of the aircraft is provided, when the airfoil is rotated about its axis by 90 degrees up, i. e. into a vertical position in which the airflow from the outlet is directed downward, a vertical flight of the aircraft is provided. Also, by deflecting the outer airfoil panels by a desired angle, the angular position of the aircraft, i. e. flight maneuvering, is changed. Thus, an effective aircraft control is provided at any time. Besides, using the described principle provides opportunities for safe landing in case of the power source landing failures.

It is obvious that the air-supply-duct is executed in the inner cavity of the airfoil and is also characterized by the presence of an inlet for communicating with the interior of the rotor enclosure, and its outlet is substantially the outlet opening on the side of the airfoil trailing edge.

According to the present invention the airfoil is provided with an airfoil end member coupled with the outlet opening, which allows for providing the required output airflow speed and thereby improving the aircraft control efficiency, ensuring a high flight stability.

Preferably said airfoil rotates with respect to the airfoil axis by 90 degrees up and 90 degrees down, in other words can rotate with respect to the airfoil axis by 180 degrees, which allows for providing the required level of the aircraft controllability.

Also preferably the rotor enclosure has a substantially cylindrical shape and can be made of metals, polymers, composite and/or any other materials widely utilized in the relevant arts. The rotor enclosure preferably secures a pair of counterrotating rotors that act as the main lift generating components of the present invention. The rotors are driven by a power source that generates a torque through a powered axle. Each rotor acts as an airfoil that generates an area of low pressure above the rotor and lifting the flight cabin. Each rotor blade may be constructed out of a rigid steel sheet, polymer panels, or like materials that twist about the radial axis. The rotor axis is integrated with the powered axle of the power source. The rotor axis may utilize a gearing mechanism to enable the first set of rotors to rotate in the direction opposite the second set of rotors.

The rotor enclosure is concentrically mounted to the rotor axis through a high strength mechanical bond. The mechanical bond allows the rotor to rotate while the rotor enclosure remains stationary. This creates a more aerodynamic profile in the front of the present aircraft, which reduces drag and increases the top speed. The rotor enclosure also reduces the effect of retreating rotor blade stall. Since the speed of the airflow over the retreating rotor blade slows down, it is possible that they may experience stall, which greatly increases the chances of a crash. The rotor enclosure thus deflects the air around the rotors which reduces the severity of this effect.

The flight cabin can be positioned below or above the rotor enclosure and contains the flight cockpit and flight instruments. The flight cockpit comprises windows allowing the pilot to examine the exterior of the present invention without being exposed to outside elements. Doors are rotatably or slidably mounted into openings in the flight cockpit and allow the pilot's selective access therein. The flight cockpit houses various electronic flight instruments, flight controls, flight communications, and like components. The flight control inputs help the pilot to control heading, speed, altitude, vertical speed, vertical navigation, and lateral navigation of the present invention. Flight controls inputs may include but are not limited to typical rotorcrafts control devices such as a cyclic stick, a collective lever, and anti-torque pedals. Alternate embodiments of the present invention may be remotely controlled thus obviating the need for a cockpit. In such an embodiment, a pilot located at a remote area may control the present invention via wireless carrier waves data embodying flight control inputs. For example, a person with a remote control may fly the present invention by looking at the aircraft from the ground.

According to the invention the power source may utilize components and arrangements well known in the relevant arts. The power source may utilize conventional energy sources such as a chemical energy source, an electrical energy source, or any other available energy source that can be safely stored within the flight cabin. For example, a gas powered internal combustion engine may provide torque to the rotor axis through the powered axle. In another embodiment, an electrical motor in the form of a stator positioned concentrically around an armature connected to the central hub may provide the primary motive force. An electric current running through the armature creates torques when it interacts with the magnetic field created by the stator. This provides rotational force that can power the rotor. Various additional features used in the relevant fields may be included in alternate embodiments of the present invention.

In another preferred embodiment of the VTOL aircraft said aircraft comprises a central rotor and a tail rotor, each being arranged in the individual rotor enclosure mounted along the flight cabin longitudinal axis. In such a case said aircraft comprises two airfoils, a first one being attached to the central rotor enclosure and the second one being attached to the tail rotor enclosure.

And in another preferred embodiment of the propulsion system said propulsion system comprises a central rotor and a tail rotor, each being arranged in the individual rotor enclosure. In such a case the airfoil is provided with an airfoil end member coupled with the outlet opening.

And in another preferred embodiment of the propulsion system said propulsion system comprises a central rotor and a tail rotor, each being arranged in the individual rotor enclosure. The tail rotor pushes the tail of the present invention in the direction opposite to the spin direction of the single set of rotors. This eliminates the reaction moment generated by the single set of rotors. In case a tail rotor is utilized, an anti-torque pedal may be provided. The anti-torque pedals control the direction of the fight cabin. Applying the anti-torque pedals increases the tail rotor thrust which turns the aircraft to the desired direction.

The aspects of the present invention are described herein with reference to the drawings.

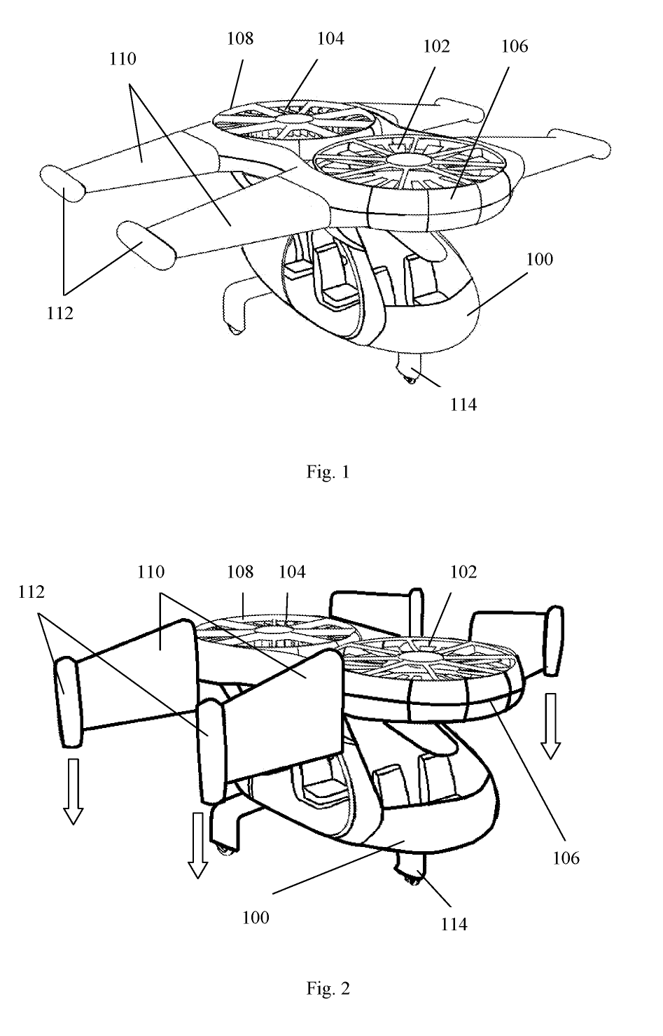

FIG. 1 depicts a perspective view of an example embodiment of the VTOL aircraft according to one of the preferred embodiments of the present invention, where the airfoils are in their initial position. The VTOL aircraft comprises a flight cabin having the central longitudinal axis extending from the flight cabin front end to the flight cabin rear end and containing a flight cockpit 100, flight instruments (not shown) and a power source (not shown). In this example embodiment of the VTOL aircraft comprises a central rotor 102 and a tail rotor 104, each being arranged in the individual rotor enclosure 106 and 108 correspondingly mounted along the flight cabin longitudinal axis. Said aircraft comprises two airfoils 110, the first one being attached to the central rotor enclosure 106 and the second one being attached to the tail rotor enclosure 108. Each airfoil 110 is provided with an air-supply-duct (not shown) connecting each rotor enclosure 106 and 108 and the airfoil end having an outlet opening (not shown) on the side of the airfoil trailing edge. In this embodiment each airfoil 110 is provided with an airfoil end member 112 coupled with said outlet opening. The VTOL aircraft is provided with a tricycle landing gear 114.

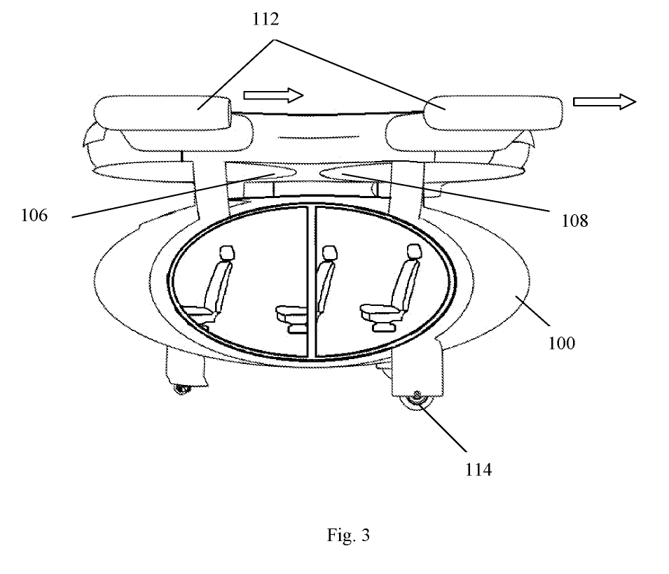

FIG. 2 depicts a perspective view of an example embodiment of the VTOL aircraft according to one of the preferred embodiments of the present invention, where the airfoils 110 are rotated by 90 degreed down in respect of their initial position for redirecting the airflow from each airfoil end member 112 coupled with the airfoil end outlet opening of each airfoil 110, wherein a vertical flight of the aircraft is provided due to such airflow redirecting.

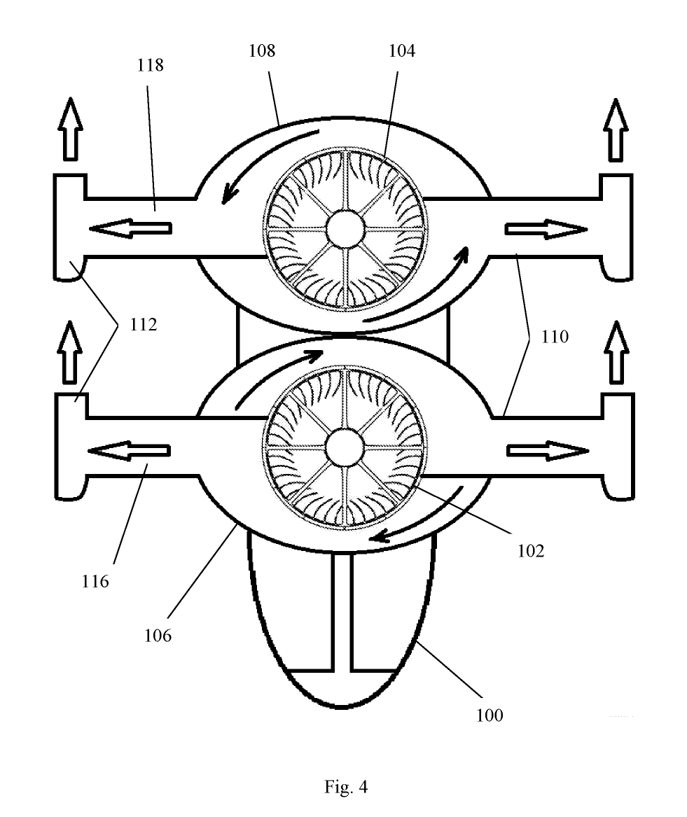

FIG. 3 depicts side view of an example embodiment of the VTOL aircraft according to one of the preferred embodiments of the present invention, where the airfoils 110 are in their initial position, wherein a horizontal flight of the aircraft is provided due to such airflow redirecting.

FIG. 4 depicts top view of an example embodiment of the VTOL aircraft according to one of the preferred embodiments of the present invention, where the air-supply-ducts 116 and 118 in each airfoil 110 are shown, said air-supply-ducts 116 and 118 are used to direct the airflow to the end members 112 of each airfoil 110.

The implementation of the invention is described herein with reference to the most preferred embodiment depicted on FIGS. 1-3 implemented as follows.

By means of the power source (not shown) the rotors 102 and 104 are activated by transmitting the torque through the powered axle of the power source to the rotor axes. Each rotor 102 and 104 generates an airflow which, at least partially through the air-supply-duct 116 and 118 provided in each airfoil 110, is directed to the end members 112 of each airfoil 110, providing a simultaneous four point airflow output to control the aircraft by controlling the resulting reactive force for its spatial position change. The rotors 102 and 104 partially act as the airfoils 110 that generate the areas of low pressure above said airfoils 110 for lifting the flight cabin. For a vertical take-off, landing and a vertical flight, the appropriate flight controls inputs transmit the control signals to the airfoils 110 for rotating them by 90 degrees up from their initial position shown in FIG. 1, wherein the airflow discharged from the end members 112 of the airfoils 110 is directed downward. For effectuating a horizontal flight, the appropriate flight controls inputs transmit the control signals to the airfoils 110 for rotating them to their initial position shown in FIG. 1. To change the angular position of the aircraft in accordance with the requirements of this particular situation the appropriate flight controls inputs transmit control signals to the airfoils 110 for smooth rotation of the airfoils 110 with respect to their axis by the desired angle to the right and/or to the left with respect to the flight cabin 100 central longitudinal axis.

The said embodiments of the vehicle, in particular the VTOL aircraft, are exemplary and do not limit the scope of claims on this application, and the claimed vehicle can be realized in the form of any vehicle characterized by the claimed design.

Although the design of the VTOL aircraft and the propulsion system were described herein in a language specific to the structural features as defined in the appended claims, it should be understood that they are not necessarily limited to the specific features described above. Rather, the specific features described above are disclosed as examples implementing the claims, and other equivalent features and steps can be encompassed by the claims of the present invention.

1. A vertical take-off and landing (VTOL) aircraft, comprising
a flight cabin having a central longitudinal axis extending from a flight cabin front end to a flight cabin rear end and containing a flight cockpit, flight instruments,
a power source mounted on the flight cabin,
at least one rotor enclosure and at least one rotor arranged in the rotor enclosure,
said rotor and rotor enclosure being concentrically mounted to a rotor axis integrated with a powered axle of the power source,
and at least one airfoil attached to said rotor enclosure and extending outward to the right and to the left with respect to the flight cabin central longitudinal axis,
wherein
said airfoil is provided with an air-supply-duct connecting the rotor enclosure and an airfoil end having at least one outlet opening on the side of an airfoil trailing edge,
said airfoil is configured to rotate with respect to an airfoil axis.

2. The VTOL aircraft according to claim 1, wherein said airfoil rotates with respect to the airfoil axis by 90 degrees up and 90 degrees down.

3. The VTOL aircraft according to claim 1, wherein the airfoil is provided with an airfoil end member coupled with the outlet opening.

4. The VTOL aircraft according to claim 1, wherein the rotor enclosure has a substantially cylindrical shape.

5. The VTOL aircraft according to claim 1, wherein the rotor enclosure is mounted to the rotor axis through a high strength mechanical bond.

6. The VTOL aircraft according to claim 1, wherein the flight cabin is positioned below or above the rotor enclosure.

7. The VTOL aircraft according to claim 1, wherein said aircraft comprises at least two counterrotating rotors arranged in the rotor enclosure.

8. The VTOL aircraft according to claim 1, wherein said aircraft comprises a central rotor and a tail rotor, each being arranged in the individual rotor enclosure mounted along the flight cabin longitudinal axis.

9. The VTOL aircraft according to claim 8, wherein said aircraft comprises two airfoils, a first one being attached to the central rotor enclosure and the second one being attached to the tail rotor enclosure.

10. A propulsion system for a vehicle vertical take-off and landing (VTOL), comprising
at least one rotor enclosure and at least one rotor arranged in the rotor enclosure,
said rotor and rotor enclosure being concentrically mounted to a rotor axis configured to be integrate with a powered axle of the VTOL aircraft power source,
and at least one airfoil attached to said rotor enclosure and extending outward in the opposite direction with respect to the rotor enclosure lateral sides,
wherein
said airfoil is provided with an air-supply-duct connecting the rotor enclosure and an airfoil end having at least one outlet opening on the side of an airfoil trailing edge,
said airfoil configured to rotate with respect to an airfoil axis.

11. The propulsion system according claim 10, wherein said airfoil rotates with respect to the airfoil axis by 90 degrees up and 90 degrees down.

12. The propulsion system according to claim 10, wherein airfoil is provided with an airfoil end member coupled with the outlet opening.

13. The propulsion system according claim 10, wherein the rotor enclosure has a substantially cylindrical shape.

14. The propulsion system according claim 10, wherein the rotor enclosure is mounted to the rotor axis through a high strength mechanical bond.

15. The propulsion system according claim 10, wherein said propulsion system comprises at least two counterrotating rotors arranged in the rotor enclosure.

16. The propulsion system according claim 10, wherein said propulsion system comprises a central rotor and a tail rotor, each being arranged in the individual rotor enclosure.

17. The propulsion system according to claim 16, wherein said propulsion system comprises two airfoils, a first one being attached to the central rotor enclosure and the second one being attached to the tail rotor enclosure.
